(19) United States
(12) Patent Application Publication
(10) Pub. No.: US 2025/0252300 A1
(43) Pub. Date: Aug. 7, 2025

(54) OPTICAL NEURAL NETWORK ACCELERATORS WITH HETEROGENEOUS THREE-DIMENSIONAL (3D) INTEGRATION

(71) Applicants: Hechen Wang, Portland, OR (US); Songtao Liu, Santa Clara, CA (US); Ram Kumar Krishnamurthy, Portland, OR (US); Mozhgan Mansuri, Portland, OR (US); Haisheng Rong, Pleasanton, CA (US)

(72) Inventors: Hechen Wang, Portland, OR (US); Songtao Liu, Santa Clara, CA (US); Ram Kumar Krishnamurthy, Portland, OR (US); Mozhgan Mansuri, Portland, OR (US); Haisheng Rong, Pleasanton, CA (US)

(21) Appl. No.: 19/094,421

(22) Filed: Mar. 28, 2025

(51) Int. Cl. G06N 3/067

(52) U.S. Cl. CPC G06N 3/0675

(57) ABSTRACT

An example optical neural network includes a first layer having a laser responsive to an input signal to transmit an optical signal, a second layer having a photodetector to generate an electrical signal based on the optical signal, and a third layer having a memory array to store weights of the optical neural network, the third layer to generate an output signal based on the electrical signal and at least one of the weights.

### BACKGROUND

Optical neural networks (ONNs) improve computing speed and reduce energy consumption for artificial intelligence (AI)-related tasks. Optical computing using ONNs results in sub-nanosecond latency, high parallelism, and reduced heat dissipation.

### BRIEF DESCRIPTION OF THE DRAWINGS

FIG. 1 illustrates a known hardware implementation of an optical neural network.

FIG. 2A illustrates a known matrix decomposition using a square decomposition, a Fast Fourier Transformation (FFT)-based decomposition, or a phase shifter.

FIG. 2B illustrates known approaches for matrix multiplication-based computation.

FIG. 3 is an exploded view of an example heterogeneous 3D integrated optical neural network constructed in accordance with teachings disclosed herein.

FIG. 4A is a perspective view of the example heterogeneous 3D integrated optical neural network of FIG. 3.

FIG. 4B illustrates the Vertical-Cavity Surface-Emitting Lasers (VCSELs) layer of FIG. 3.

FIG. 4C illustrates the Semiconductor Absorber (SA) layer of FIG. 3.

FIG. 4D illustrates the Complementary Metal-Oxide-Semiconductor (CMOS) circuit layer of FIG. 3.

FIG. 5A illustrates an example time domain partial sum accumulation with a programmable current mirror circuit.

FIG. 5B illustrates the programmable current mirror circuit of FIG. 5A.

FIG. 6 illustrates another example optical neural network constructed in accordance with teachings of this disclosure.

FIG. 7 illustrates an example performance metrics comparison table associated with the optical neural network of FIG. 3.

In general, the same reference numbers will be used throughout the drawing(s) and accompanying written description to refer to the same or like parts. The figures are not necessarily to scale.

### DETAILED DESCRIPTION

Optical neural networks (ONNs) have potential for deployment as effective accelerators for artificial intelligence (AI)-based applications. Such ONNs may reduce the currently significant processing times and energy consumption associated with existing artificial neural networks. However, several obstacles associated with known ONN implementations include (1) scalability and compatibility challenges associated with planar structures, (2) issues with weight precision, and (3) memory bottleneck and throughput limitations. Known phase shifter-based planar ONNs impose topology constraints on the network, severely limiting the applications known ONNs can support. This limitation stems from requirements on the physical mechanism and/or layout of known photonic components, restricting the network's ability to scale and adapt to diverse computational needs. Inflexibility in known designs not only hampers versatility but also impedes ONN integration with existing technologies, making such known networks a less attractive option for many applications.

The precision of weights in known ONNs represents another challenge. The non-linear nature of known ONN phase shifters can greatly reduce an effective number of bits (eNoB) to values as low as 2-3 bits. This level of precision aligns more closely with binary or ternary neural networks, rather than the higher precision required for most contemporary neural network applications. Compromised inference accuracy due to limited precision further diminishes the feasibility of known ONNs as a reliable computational accelerator. While known ONNs have impressive theoretical throughput capabilities, these known networks face practical challenges associated with data handling that can bottleneck their performance. Known ONN architectures allow for rapid and efficient computation at a processing element (PE) or multiply-accumulation (MAC) operation level, where multiplication operations occur swiftly. However, the overall system throughput is throttled by the slow pace of feeding new input data, loading new weights, and converting optical signals back to digital form. This discrepancy between theoretical and real-world performance highlights a significant gap in known ONN's ability to handle practical workloads effectively.

Methods and apparatus disclosed herein introduce ONN accelerators with heterogeneous three-dimensional (3D) integration for improved performance in complex computational tasks (e.g., AI-based applications). Three-dimensional integration disclosed herein is highly scalable, and capable of supporting many (e.g., any) desired network topolog (ies). For example, ONN accelerators disclosed herein include Vertical-Cavity Surface-Emitting Lasers (VCSELs) and/or Semiconductor Amplifier Lasers (SALs) that offer multibit support with reasonable linearity performance, surpassing that of Mach-Zehnder Interferometer (MZI) or wavelength division multiplexing (WDM) phase shifters. Methods and apparatus disclosed herein effectively address memory bottlenecks, ensuring that input activations and weights are updated and delivered to the computing unit promptly, without significant delays. Additionally, heterogeneous integration eliminates limitations in each layer of the ONN, with memory cells fabricated using advanced node technology to enhance density, while photonic devices are implemented on the most efficient technology nodes. In examples disclosed herein, through-silicon-vias (TSVs) facilitate rapid and efficient data movement between the ONN layers. Methods and apparatus disclosed herein support optical computing using an ONN that includes, for example, a large-scale VCSEL cell array on a first layer of the ONN architecture, a semiconductor absorption (SA) cell array on a second layer, and static random-access memory (SRAM), analog to digital converters (ADCs), and digital to analog converters (DACs) on a third layer.

In examples disclosed herein, the 3D heterogenous integration of the ONN architecture implements two optical layers (e.g., the VCSEL layer and the SA layer) using an optically preferred process node, while a third layer (e.g., a complementary metal-oxide-semiconductor (CMOS) circuit layer) can be independently fabricated using the most advanced CMOS node(s) available (e.g., to enhance memory density and support larger networks). Additionally, positioning ADCs and/or DACs on the CMOS layer improves conversion efficiency and speed. The converted data can be directly delivered to the optical computing unit through TSVs, bypassing the inefficient and latency-prone long-distance inter-chip communication channels of known systems. Methods and apparatus disclosed herein resolve the critical data movement bottleneck of known ONNs, unlocking the full potential of ONNs for real-world applications associated with complex computational tasks.

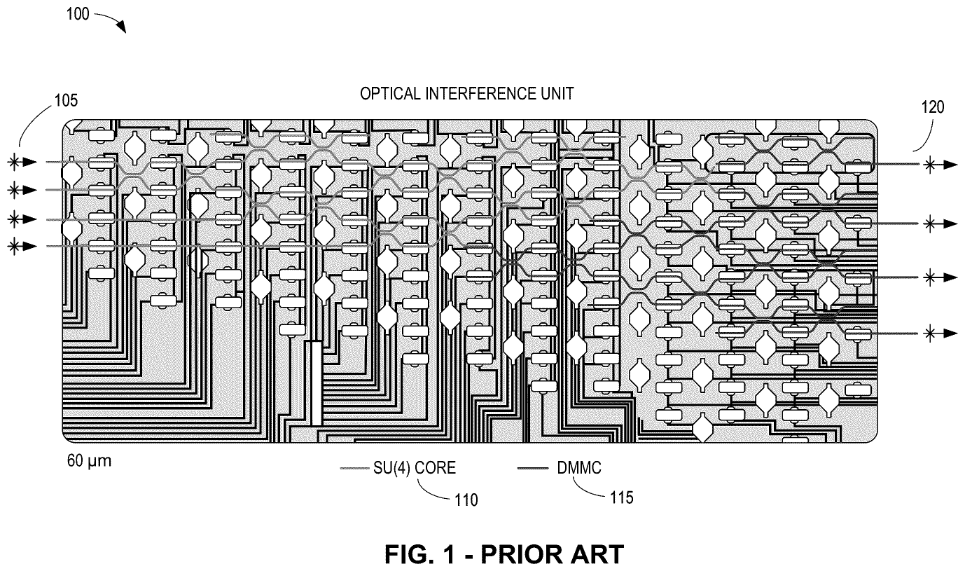

FIG. 1 illustrates a known hardware implementation 100 of an optical neural network. FIG. 1 shows an optical micrograph illustration of an optical inference unit (OIU) that receives a laser light input 105 and performs fully optical matrix multiplication and attenuation using an SU(4) core 110 and a diagonal matrix multiplication core (DMMC) 115, respectively, resulting in an output 120. Known hardware implementations 100 involving OIUs focus on optical data transmission as opposed to optical computing. For example, a significant challenge in the development of ONNs is the scalability of planar structures. Phase shifter-based planar ONNs impose stringent constraints on network topology, severely limiting their applicability and the range of applications that ONNs can support. The planar structure fails to meet the demands of more complex computing tasks that require flexible and adaptable network configurations. Additionally, while known ONNs show high computational efficiency associated with multiply-accumulation (MAC) operations, such ONNs do not reflect system-level throughput or overall efficiency during deployment, representing a bottleneck in the memory access bandwidth. As such, despite the ability of the known hardware implementation 100 of FIG. 1 to rapidly and efficiently perform a large number of MAC operations in parallel, the overall performance of such known ONNs is significantly hampered when used in real-world complex computing applications, as the currently available structures cannot deliver the input activation and weight(s) to the processing unit in time to match the MAC computation speed.

Some known ONNs include a 64×64 MAC array operating at 1 GHz that achieves a throughput of 8.2 Tera Operations per Second (TOPS) (e.g., using an INT-8 operation). The optical computing component alone consumes 92.6 milliwatts (mW), translating to an efficiency of 88.6 TOPS/W. When including the power consumption of the data converters (ADCs and DACs), the total power usage increases to 287.5 mW, resulting in an efficiency of 28.5 TOPS/W. While such efficiencies are highly competitive when compared to traditional computing units (e.g., Central Processing Units (CPUs), Graphics Processing Units (GPUs), Tensor Processing Units (TPUs), etc.), the overall system power consumption for the ONN escalates to 3 W, which reduces the actual power efficiency to only 2.7 TOPS/W (e.g., with a majority of the power expended in data movement). Methods and apparatus disclosed herein address the existing discrepancy between computing power and practical throughput associated with ONNs, enhancing memory integration and access to achieve the full potential of ONNs in the field of optical computing.

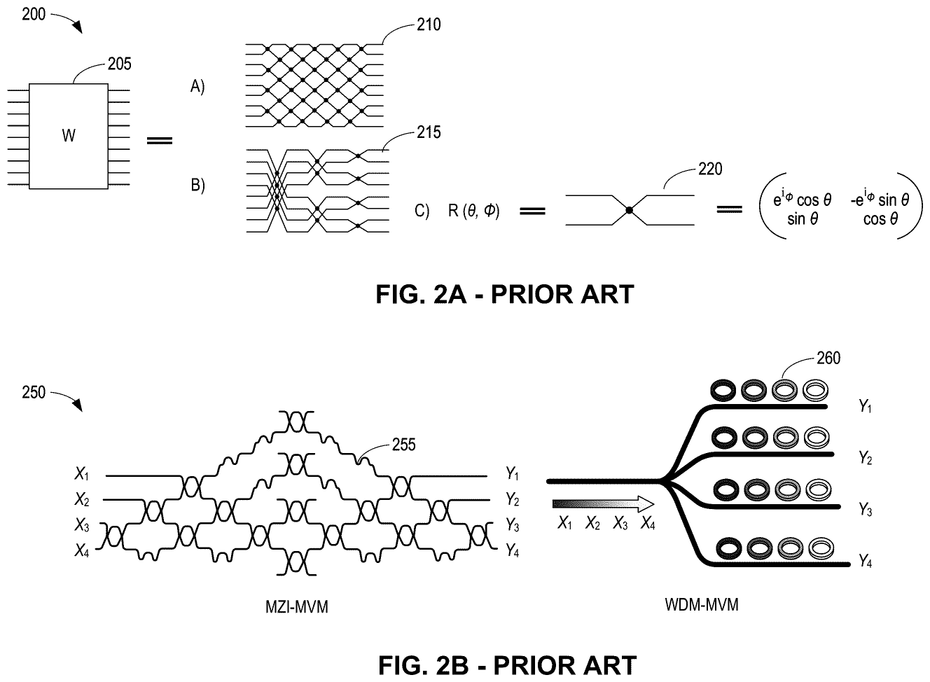

FIG. 2A illustrates a known matrix decomposition 200 using a square decomposition, a Fast Fourier Transformation (FFT)-based decomposition, or a phase shifter. An ONN is built on the principle that any N×N matrix W can be represented as a product of rotation matrices and a diagonal matrix D. As shown in FIG. 2A, an arbitrary matrix W 205 can be decomposed using a square decomposition 210 or approximated by an FFT-style decomposition 215, where each graph junction associated with the decomposition(s) 210, 215 represents a phase shifter or multiplier matrix 220, with the photonic phase shifter described in more detail in connection with FIG. 2B.

FIG. 2B illustrates known approaches 250 for matrix multiplication-based computation. The formation of a photonic phase shifter and construction of a matrix-vector multiplications (MVMs) array can be performed using multi-plane light conversion (MPLC), a Mach-Zehnder interferometer (MZI), and/or wavelength division multiplexor (WDM). FIG. 2B illustrates an MZI-MVM configuration diagram 255 and a WDM-MVM configuration diagram 260. MPLC-MVM is implemented using a diffraction of light in free space, which is not casily integrated on silicon. The MZI-MVM configuration diagram 255 focuses on rotation submatrix decomposition and singular value decomposition. The calibration of the transmission matrix is more complex given that every matrix element is affected by multiple dependent parameters. The WDM-MVM configuration diagram 260 represents a diagram based on microring resonators (MRRs), where an input vector of X is loaded on beams with different wavelengths which pass through the microrings with a one-one adjustment of the transmission coefficients of W, with a total output power vector represented by Y=WX.

For example, as described in connection with FIG. 2B, optical neural networks leverage light for matrix multiplication as part of accelerating computations and reducing energy consumption. Optical components (e.g., such as MRRs) or diffractive elements can be used to perform the matrix-vector multiplication, such that weights are represented by optical properties. Linear operations in neural networks generally involve a large amount of matrix multiplications, which are needed to efficiently process data and learn weights (e.g., parameters determined during a training phase), with input data and weights represented as matrices (e.g., arrays) that are multiplied to compute the output of each layer of the neural network. In the optical neural network disclosed herein, an array of signals can be multiplied by an array of weights, resulting in a matrix of output data where each position of the matrix represents a product of the input signal and a corresponding weight of a corresponding node.

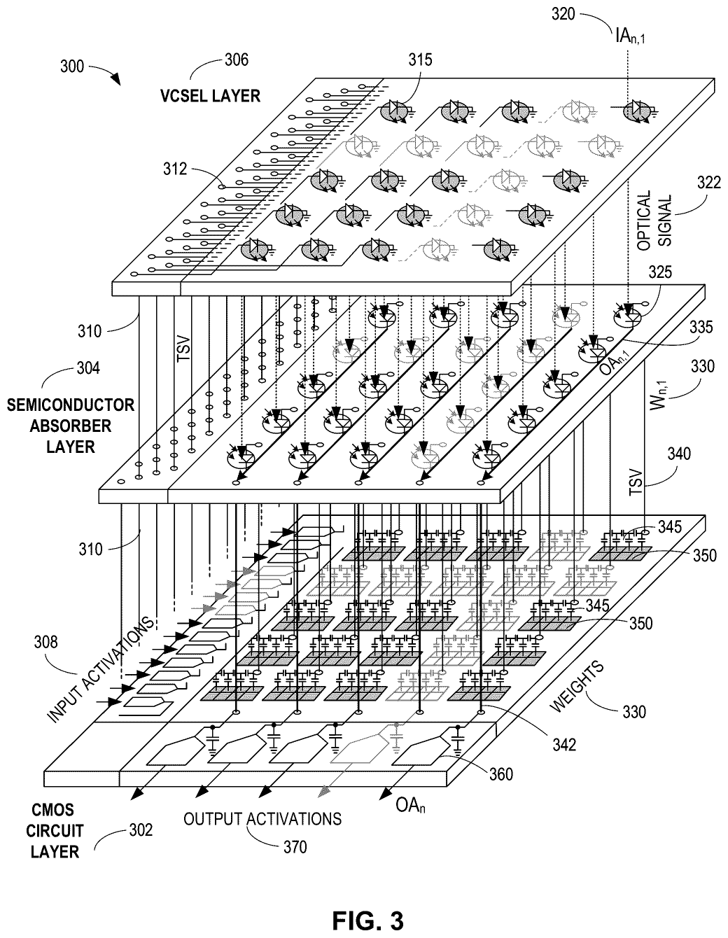

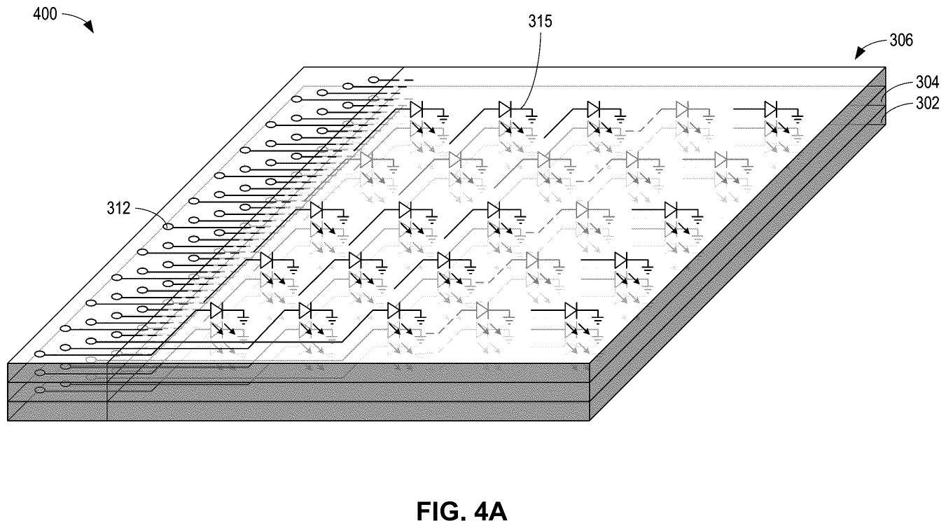

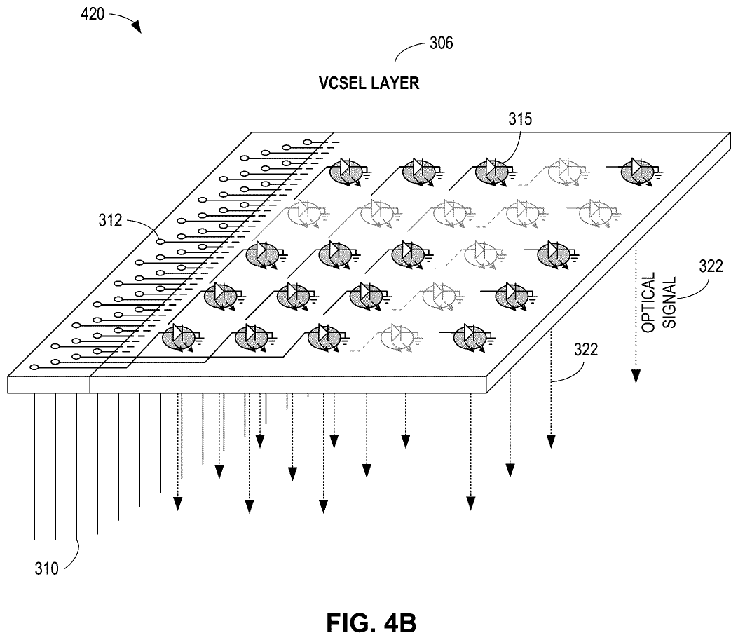

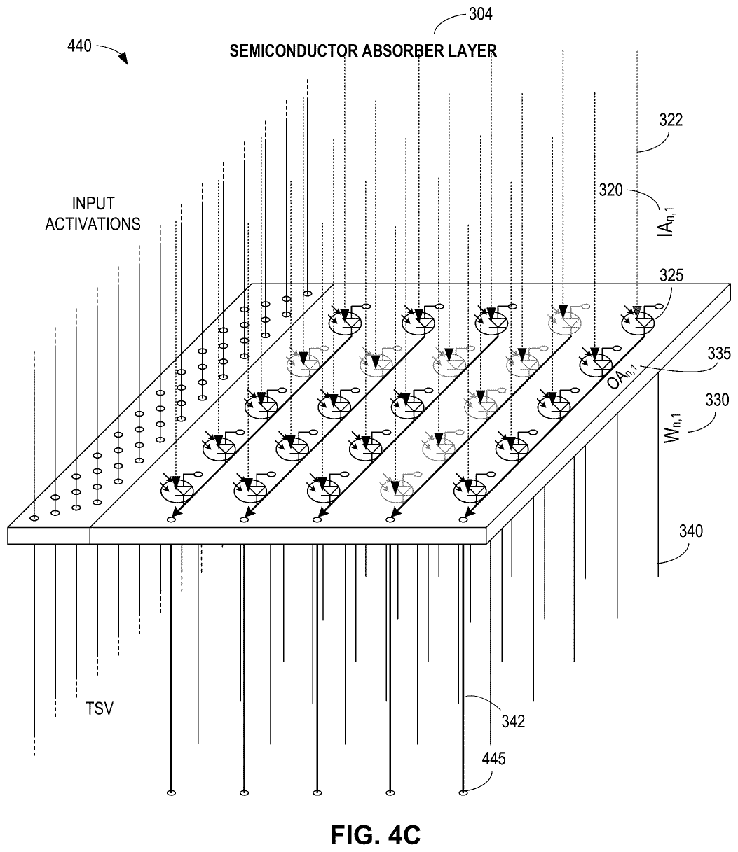

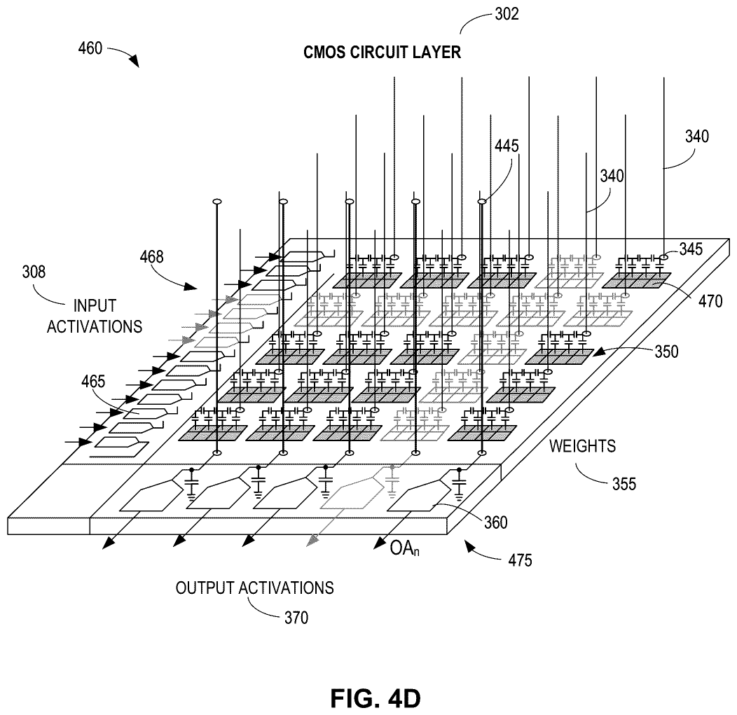

FIG. 3 is an exploded view of an example heterogeneous 3D integrated optical neural network 300 disclosed herein. The ONN 300 of FIG. 3 includes a CMOS circuit layer 302, a semiconductor absorber (SA) layer 304, and a vertical-cavity surface-emitting lasers (VCSEL) layer 306. For example, the CMOS circuit layer 302 includes input activation digital to analog converters (DACs), which are responsible for converting digital input activation signals 308 into analog signals. These analog signals can be transmitted using through-silicon-via(s) (TSVs) 310, 312 to respectively drive VCSEL unit(s) 315 of an array of VCSELs located in the VCSEL layer 306. The optical signal output(s) of the VCSEL unit(s) 315 correspond to the applied input signals. As such, the VCSEL layer 306 represents a first layer of the heterogeneous 3D integrated optical neural network having an array of lasers (e.g., VCSEL) responsive to input signal(s) (e.g., received from the CMOS circuit layer 302) to transmit optical signal(s) (e.g., laser-based optical signal(s) 322) to the second layer (e.g., the SA layer 304), as shown in more detail in connection with FIG. 4B.

In the example of FIG. 3, SA unit(s) 325 in the SA layer 304 receive respective ones of the optical signal(s) (e.g., represented as an Input Activation 320 (IA_{n,1})) and generate corresponding electrical signal(s) (e.g. represented as an Output Activation 335 (OA_{n,1})) in accordance with Equation 1:

$${OA}_{n , 1} = {IA}_{n , 1} \times {W}_{n , 1} \qquad Equation 1$$

In the example of Equation 1, the strength of the output signal(s) from the SA unit(s) correspond to the product of the input light strength of the respective optical signal(s) from the VCSELs and the bias of the SA unit(s) 325. This bias of the SA unit(s) 325 corresponds to the weight(s) (W_{n,1}) 330. These weights are stored in the SRAM cell(s) 350 of the CMOS circuit layer 302 and are converted through a C-2C capacitor ladder 345. Subsequently, currents from all the SA unit(s) (IA_{n,i}) 325 located in a given column are merged in accordance with Equation 2:

$${OA}_{n} = {\sum }_{i = 1}^{m} {IA}_{n , i} \times {W}_{n , i} \qquad Equation 2$$

The output activation is then transmitted via TSVs 342 to the CMOS circuit layer 302, held on a capacitor (e.g., the C-2C capacitor ladder 345), and converted using an analog to digital converter (ADC) 360 to a digital output activation (OAₙ) 370.

As such, the SA layer 304 represents a second layer of the heterogeneous 3D integrated optical neural network 300 having a plurality of photodetector(s) to generate respective electrical signals of the optical neural network 300 (e.g., a signal representative of the product of the optical signal and the bias of the SA unit(s) 325), as shown in more detail in connection with FIG. 4C. The CMOS circuit layer 302 represents a third layer having an SRAM memory array to store weights of the optical neural network, such that the third layer generates a second output signal of the optical neural network (e.g., digital output activations 370) based on the first output signal and at least one of the weights, as shown in more detail in connection with FIG. 4D. Integration of optical devices as described in examples disclosed herein allows for the decoupling of the three main components of the computing unit shown in the heterogeneous 3D integrated optical neural network 300 (e.g., the input DAC, the MAC unit, and the output ADC). This separation effectively breaks the RC constant that typically limits the speed of analog computing. As a result, the proposed ONN structure can achieve significantly higher speeds while maintaining low power consumption. This breakthrough has the potential to enhance memory integration and eliminate the data movement bottleneck, thereby unlocking the full capabilities of ONNs.

FIG. 4A illustrates a perspective view of the example heterogeneous 3D integrated optical neural network 300 of FIG. 3. In the example of FIG. 4A, the VCSEL layer 306 is shown positioned above the CMOS circuit layer 302 and the SA layer 304. The VCSEL layer 306 includes the VCSEL unit(s) 315 connected to the CMOS circuit layer 302 using TSVs 310, 312, as described in more detail in connection with FIG. 3. Despite known ONNs demonstrating high throughput and efficiency at the computing unit level, their overall system and application-level performance often lacks significant benefits and may even underperform compared to traditional acceleration methods. As such, currently available solutions do not effectively prepare input activation(s) and/or weight data in a manner that aligns with the throughput capabilities of the optical computing unit. For example, process nodes required to support photonic devices differ from those used in conventional CMOS technology. Typically, use of two separate dies is needed to accommodate photonic devices and CMOS circuits independently. This separation allows for the employment of more advanced technology nodes for CMOS circuits, enhancing data density and storage capacity on such chips. However, data transfer between chips consumes considerable power due to the need for data conversion and complex interchip communication protocols, significantly reducing overall system efficiency. Each operational cycle requires the transmission of a large volume of data, such that conventional systems are unable to match the speeds required by optical computing units. Furthermore, photonic process nodes currently do not support large-scale memory integration, which restricts the applications that such accelerators can support.

The existing discrepancy between a given computing unit and practical system throughput highlights a critical challenge in the field of optical computing, which focuses on enhancing memory integration and access to fully leverage the capabilities of ONNs. In heterogeneous 3D integrated optical neural networks 300 disclosed herein, two optical layers (e.g., the SA layer 304 and the VCSEL layer 306) can be implemented using an optically preferred process node, while a third layer (e.g., the CMOS circuit layer 302) can be independently fabricated using the most advanced CMOS node available to enhance memory density to support larger networks. In examples disclosed herein, positioning a data converter on the CMOS layer 302 can be used to optimize conversion efficiency and speed, allowing the converted data to be directly delivered to the optical computing unit through TSVs (e.g., TSVs 312 of FIG. 3), bypassing inefficient and latency-prone long-distance inter-chip communication channels.

FIG. 4B shows an example illustration 420 of the Vertical-Cavity Surface-Emitting Lasers (VCSELs) layer 306 of FIG. 3. In the example of FIG. 4B, each VCSEL cell 315 within the VCSELs layer 306 is driven by a bias voltage produced by an input DAC (e.g., positioned on the CMOS circuit layer 302) based on Input Activation (IA) data. For example, the light strength of the optical signals 322 of FIG. 3 emitted from the VCSELs layer 306 is related to the IA data. In particular, the signal in the optical domain is embedded in the laser strength, modulated by a bias voltage. The DAC converts the digital input data into an analog voltage signal, which is then applied to the laser device as its bias voltage. For example, the digital data is converted to an analog bias voltage via the DAC, and this bias voltage is subsequently converted into a strength-modulated light. In examples disclosed herein, the IA signal can (1) fan out to multiple VCSEL cells 315 to distribute the power required for DAC generation more efficiently or (2) maintain a one-to-one ratio to improve throughput. As such, the network can be optimized based on specific performance or power consumption needs.

FIG. 4C shows an example illustration 440 of the Semiconductor Absorber (SA) layer 304 of FIG. 3. In the example of FIG. 4C, each SA cell 325 in the SA layer 304 corresponds to a photodetector that receives an IA-modulated laser from the VCSELs layer 306 (e.g., receiving an input activation (IA) 320). Each SA cell 325 is also controlled by a bias voltage, which corresponds to the weight(s) (W) 330 stored in the SRAM array (e.g., SRAM cell(s) 350 located on the CMOS circuit layer 302). As previously described, this bias voltage represents the weight value, which is stored in the SRAM cell. The weight value represents digital data and is converted to an analog voltage through the C-2C capacitor ladder located beside the SRAM cell. This bias voltage is delivered directly via TSVs 340, bypassing the SRAM Input/Output (I/O) interface, which effectively eliminates any memory-related throughput bottlenecks. In the example of FIG. 4C, the electrical current generated by the SA cell(s) 325, representing the Output Activation (OA) 335, is the product of the IA 320 and the weight 330 (W). The OAs 335 accumulate in the current domain through the connection of all the outputs from the SA cell(s) 325 together, allowing for the aggregation of current signals from multiple SA cell(s) 325, facilitating the summation of their individual contributions to form a final output 445, which is transmitted to the CMOS circuit layer 302 (e.g., via TSVs 342). As such, the photodetector has two inputs corresponding to light strength and bias voltage (V_{bias}). The output of the photodetector is a current (Iₒᵤₜ), whose amplitude corresponds to the product of the two inputs, represented as Iₒᵤₜ=V_{bias}*light_strength.

FIG. 4D shows an example illustration 460 of the Complementary Metal-Oxide-Semiconductor (CMOS) circuit layer 302 of FIG. 3. In the example of FIG. 4D, the CMOS circuit layer 302 includes input activation digital to analog converters (DACs) 465, a weight storage SRAM array 350, and output activation analog to digital converters (ADCs) 360. In some examples, C-2C capacitor-based low overhead DACs 465 are placed at a first edge 468 of the CMOS circuit layer 302 to convert digital input activation (IA) 308 data into analog signals, which are then transmitted to the VCSEL cell(s) 315 on the VCSEL layer 306 using TSVs 310, 312 of FIG. 3. In the example of FIG. 4D, weights are stored in the SRAM array(s) 350, with each SA cell 325 on the SA layer 304 linked to a specific sub-array containing multiple SRAM banks. In each cycle, a single bank 470 connects to an in-memory C-2C capacitor ladder 345, converting stored digital weights 355 into analog bias voltages that are directly fed to the SA cell(s) 325 through TSVs 340, bypassing bandwidth-limited SRAM I/O interfaces for rapid data delivery. As such, methods and apparatus disclosed herein effectively eliminate the ONN-based memory bottleneck, greatly improving throughput and enhancing overall system efficiency. Additionally, accumulated Output Activation (OA) signals in the current domain are sent from the SA layer 304 to the CMOS circuit layer 302, converted to voltage by a summation capacitor (e.g., as described in more detail in connection with FIG. 3), and digitized by ADCs 360 for the final output activations 370 in each column at a second edge 475 of the CMOS circuit layer 302.

In examples disclosed herein, in-memory computing uses C-2C capacitor ladder(s) 345 for converting weight data into bias voltage (e.g., as opposed to other approaches that use C-2C capacitors for computational purposes). In examples disclosed herein, the actual computing is performed in the optical domain using photonic devices. As such, the separation of DACs, multiply-accumulation (MAC) unit(s), and ADCs decouples these components, alleviating constraints that reduce operational speed. For example, using the C-2C capacitor ladder(s) 345 for MAC computations requires the IA DACs to have sufficient driving capability to charge the capacitors, which is not feasible with a capacitor-based DAC due to inadequate driving strength. Some known techniques include the use of an R-2R resistor ladder for building the DAC, but such a ladder consumes constant power, with the resistance on the R ladder connected to capacitance on the C ladder in the MAC unit. For example, the capacitance C can be determined by a kT/C sampling noise requirement (e.g., where k is Boltzmann's constant, T represents the absolute temperature, and C is the capacitance), while the resistance R is identified by an implementation mismatch (e.g., obtained with Monte Carlo simulations).

To achieve 8-bit precision, the required minimum capacitance is approximately 2 femtofarads (fF), while the resistance is approximately 2.5 k ohms. While the theoretical frequency upper bound is less than 1/(2πRC)/5, the RC network can require at least five times of 2πRC time to be 99% settled. Therefore, due to physical limitations, the maximum speed the charge domain in-memory computing can support is 6.4 gigahertz (GHz). In contrast, the proposed ONN architecture disclosed herein avoids these limitations. For example, the IA DAC (e.g., serving as a bias voltage generator) does not require driving capability, allowing the use of the C-2C capacitor ladder(s) 345 that does not consume constant power and avoids forming an RC constant with the VCSEL cell(s) 315 on the VCSEL layer 306. This absence of speed limitations allows photonic devices to operate at bandwidths reaching tens of gigahertz, significantly enhancing throughput beyond what previous analog Charge-in-Memory (CiM) could support.

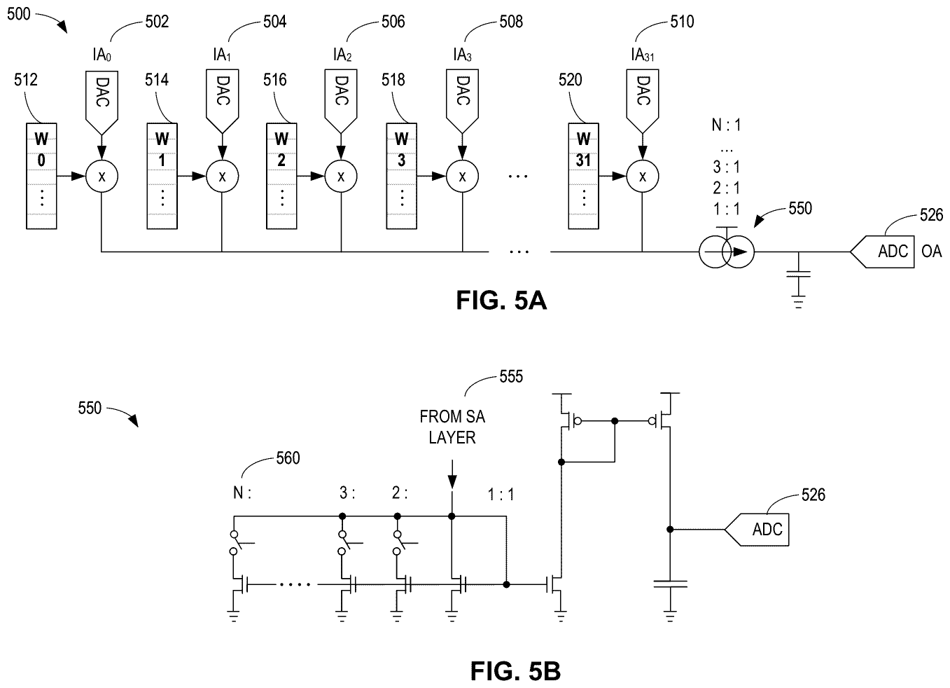

FIG. 5A illustrates an example time domain partial sum accumulation 500 with a programmable current mirror circuit 550. For example, massive parallel neural network accelerators often encounter an underutilization problem, where the number of MAC summations is less than that provided by available hardware. In most existing accelerator designs, the hardware structure is fixed, leading to unused MAC units being padded with zeros. While this does not introduce any challenges for computation in a digital domain (e.g., except for zero-padding, which can potentially lower the power efficiency of the hardware), in the analog domain, padding zeros effectively lowers the dynamic range of the signal sent to the ADC, resulting in reduced precision during the digitization process. This reduction in dynamic range can also significantly impact the accuracy and performance of the optical neural network system.

For example, the size of MAC summation (e.g., input channel size) between 16 to 64 represents an optimal range. Below this range, efficiency significantly drops due to a low amortization ratio, while above this range, given the distribution of neural network layer sizes, more than half of the layers tend to be underutilized. Methods and apparatus disclosed herein perform accumulation in the time domain and adjust the current ratio to prevent overflow. For example, the hardware summation size is fixed at 32 elements per column. If the accumulation required for a neural network layer is 32 or fewer, the programmable current mirror circuit 550 sets the ratio at 1:1. In the example of FIG. 5A, the Input Activations (IAs) are shown for a total of 31 accumulations (e.g., IAᵢ represented by IA₀ 502, IA₁, 504, IA₂ 506, IA₃ 508, IA₃₁ 510), where the IAs are multiplied by corresponding weight inputs (Wᵢ represented by W₀ 512, W₁ 514, W₂ 516, W₃ 518, W₃₁ 520). For accumulations exceeding 32 (e.g., such as 96 accumulations), the hardware can be re-used three times to compute three partial sums (e.g., Σᵢ₌₀³¹IAᵢ×Wᵢ, Σᵢ₌₃₂⁶³IAᵢ×Wᵢ, and Σᵢ₌₆₄⁹⁵IAᵢ×Wᵢ). These sums are held on an output capacitor before reaching the ADC 526. Since the capacitor is charged three times in such scenarios, there is a risk that the total charge may exceed capacity. To mitigate the risk of the total charge exceeding capacity, the current mirror can be adjusted to a 3:1 ratio, reducing the range of each partial sum to ensure there is no overflow.

FIG. 5B illustrates the programmable current mirror circuit 550 of FIG. 5A. In the example of FIG. 5B, the programmable current mirror circuit 550 adjusts the current ratio to prevent overflow during accumulations in the time domain. In the example of FIG. 5B, an input 555 is received at the CMOS circuit layer 302 (e.g., from the SA layer 304) corresponding to the accumulated Output Activation (OA) signals in the current domain. For example, the OA signals are converted to voltage by a summation capacitor and digitized by ADC 526. As described in connection with FIG. 5A, the programmable current mirror circuit 550 sets the current ratio 560 at 1:1 when accumulations required for a neural network layer are 32 or fewer, while the current ratio 560 can be set to 3:1 when accumulations exceed 32 accumulations.

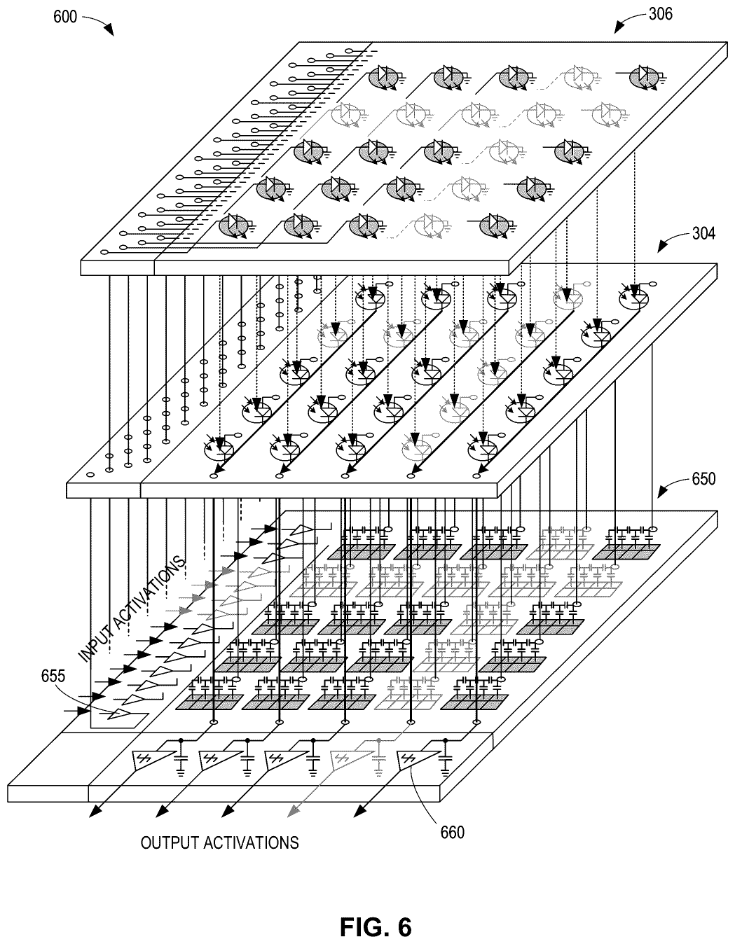

FIG. 6 illustrates an example alternative optical neural network 600 using an analog buffer and comparator. In the example of FIG. 6, the optical neural network 600 includes the SA layer 304 and the VSCEL layer 306 of FIG. 3. However, the CMOS circuit layer 302 is replaced by CMOS circuit layer 650. For example, in the CMOS circuit layer 302, the output activation analog to digital converters (ADCs) 360 represent a major power consumer and consequently a major speed limiter in the optical neural network system. In the example of FIG. 6, the ADCs 360 and DACs 465 can be replaced by analog buffer(s) 655 at the input and comparator(s) 660 at the output to further reduce power consumption. By adjusting the threshold voltages of the comparator(s) 660, the optical neural network 600 can support spiking neural networks for neuromorphic computing applications. This adjustment of the neural network improves system energy efficiency and expands the system's applicability to more computational models, leveraging the inherent properties of spiking networks for more realistic simulations and processing.

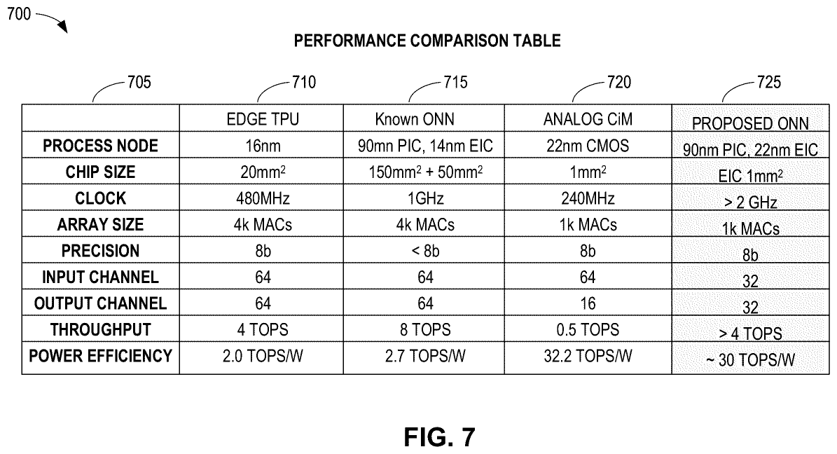

FIG. 7 illustrates an example performance metrics comparison table 700 associated with the optical neural network 300 of FIG. 3. In the example of FIG. 7, the assessed parameters 705 include process node type, chip size, array size, throughput, and power efficiency. Several known computing systems (e.g., Google® Edge Tensor Processing Unit (TPU) 710, a known photonic chip 715, analog Computer-in-Memory (CiM) computing architecture 720) are compared to the optical neural network (e.g., proposed ONN 725) disclosed herein. The results of FIG. 7 indicate that the proposed ONN 725 has a high power efficiency (e.g., as indicated by a higher TOPS/W ratio associated with more efficient hardware utilization) and a correspondingly high throughput (e.g., based on the number of computing operations handled in one second), such that a higher TOPS value corresponds to faster performance.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

From the foregoing, it will be appreciated that example systems, methods, apparatus, and articles of manufacture disclosed herein introduce an ONN accelerator with heterogeneous three-dimensional (3D) integration for improved performance of ONNs in complex computational tasks. Methods and apparatus disclosed herein effectively address memory bottlenecks, ensuring that input activations and weights are updated and delivered to the computing unit promptly. In examples disclosed herein, through-silicon-vias (TSVs) facilitate rapid and efficient data movement between the ONN layers. Methods and apparatus disclosed herein support optical computing using an ONN that includes a large-scale VCSEL cell array on a first layer of the ONN architecture, an SA cell array on a second layer, and an array including static random-access memory (SRAM), an analog to digital converter (ADC), and a digital to analog converter (DAC) on a third layer. Thus, examples disclosed herein result in improvements to the operation of a machine.

Example methods, apparatus, systems, and articles of manufacture for efficient and accurate visual tasks using dynamic neural network scheduling are disclosed herein. Further examples and combinations thereof include the following:

Example 1 includes an optical neural network, comprising a first layer having a laser responsive to an input signal to transmit an optical signal, a second layer having a photodetector to generate an electrical signal based on the optical signal, and a third layer having a memory array to store weights of the optical neural network, the third layer to generate an output signal based on the electrical signal and at least one of the weights.

Example 2 includes the optical neural network of example 1, wherein the first layer, the second layer, and the third layer are heterogeneously integrated.

Example 3 includes the optical neural network of example 1 and/or example 2, wherein the laser is a vertical-cavity surface-emitting laser (VCSEL), the second layer includes a semiconductor absorber (SA) layer, and the third layer includes a complementary metal-oxide-semiconductor (CMOS) circuit layer.

Example 4 includes the optical neural network of any one or more of examples 1-3, wherein the second layer is to transmit the electrical signal to the third layer by a through-silicon-via (TSV).

Example 5 includes the optical neural network of any one or more of examples 1-4, wherein the third layer is to generate the output signal based on a bias associated with the at least one of the weights of the optical neural network.

Example 6 includes the optical neural network of any one or more of examples 1-5, wherein the memory array of the third layer includes at least one static random memory (SRAM) cell.

Example 7 includes the optical neural network of any one or more of examples 1-6, wherein the third layer includes at least one of an analog buffer to process the input signal or a comparator to process an output signal.

Example 8 includes an optical neural network, comprising a complementary metal-oxide-semiconductor (CMOS) circuit layer to receive an input signal and to store weights of the optical neural network, a vertical-cavity surface-emitting laser (VCSEL) layer to convert the input signal to an optical signal, and a semiconductor absorber (SA) layer to generate an output signal of the optical neural network based on the optical signal and the weights of the optical neural network.

Example 9 includes the optical neural network of example 8, wherein a VCSEL layer includes a VCSEL cell to receive a bias voltage produced by a digital-to-analog converter.

Example 10 includes the optical neural network of example 8 and/or example 9, wherein the SA layer includes semiconductor absorber cells to receive the optical signal from the VCSEL layer, a through-silicon-via (TSV) to deliver a bias voltage from the VCSEL layer to the SA layer.

Example 11 includes the optical neural network of example 8, wherein the SA layer is to generate the output signal based on an accumulation of outputs from two or more semiconductor absorber cells.

Example 12 includes the optical neural network of any one or more of examples 8-11, wherein the CMOS circuit layer stores one or more of the weights in a static random memory (SRAM) bank, the SRAM bank connected to an in-memory C-2C capacitor ladder to convert a corresponding one of the weights to a bias voltage.

Example 13 includes the optical neural network of any one or more of examples 8-12, wherein a programmable current mirror circuit of the VCSEL layer includes a three to one (3 1) current ratio during a time domain partial sum accumulation.

Example 14 includes an apparatus, comprising means for generating an optical signal responsive to an input signal at a first layer of an optical neural network, means for generating an electrical signal based on the optical signal at a second layer of the optical neural network, and means for generating an output signal based on the electrical signal, the electrical output signal a product of the optical signal and a weight of the optical neural network stored at a third layer of the optical neural network.

Example 15 includes the apparatus of example 14, wherein the first layer, the second layer, and the third layer are heterogeneously integrated.

Example 16 includes the apparatus of example 14 and/or example 15, wherein the first layer is a vertical-cavity surface-emitting lasers (VCSELs) layer, the second layer is a semiconductor absorber (SA) layer, and the third layer is a complementary metal-oxide-semiconductor (CMOS) circuit layer.

Example 17 includes the apparatus of any one or more of examples 14-16, wherein the means for generating the electrical signal is to generate a photodetector output based on a bias associated with a corresponding one of the weights of the optical neural network.

Example 18 includes the apparatus of any one or more of examples 14-17, wherein the one of the weights of the optical neural network is stored on a static random memory (SRAM) cell of the third layer.

Example 19 includes the apparatus of any one or more of examples 14-18, wherein the third layer includes at least one of an analog buffer to process the input signal or a comparator to process the output signal.

Example 20 includes the apparatus of any one or more of examples 14-19, wherein the second layer is to generate the output signal based on an accumulation of outputs from two or more semiconductor absorber cells.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An optical neural network, comprising:
a first layer having a laser responsive to an input signal to transmit an optical signal;
a second layer having a photodetector to generate an electrical signal based on the optical signal; and
a third layer having a memory array to store weights of the optical neural network, the third layer to generate an output signal based on the electrical signal and at least one of the weights.

2. The optical neural network of claim 1, wherein the first layer, the second layer, and the third layer are heterogeneously integrated.

3. The optical neural network of claim 1, wherein the laser is a vertical-cavity surface-emitting laser (VCSEL), the second layer includes a semiconductor absorber (SA) layer, and the third layer includes a complementary metal-oxide-semiconductor (CMOS) circuit layer.

4. The optical neural network of claim 1, wherein the second layer is to transmit the electrical signal to the third layer by a through-silicon-via (TSV).

5. The optical neural network of claim 1, wherein the third layer is to generate the output signal based on a bias associated with the at least one of the weights of the optical neural network.

6. The optical neural network of claim 1, wherein the memory array of the third layer includes at least one static random memory (SRAM) cell.

7. The optical neural network of claim 1, wherein the third layer includes at least one of an analog buffer to process the input signal or a comparator to process an output signal.

8. An optical neural network, comprising:
a complementary metal-oxide-semiconductor (CMOS) circuit layer to receive an input signal and to store weights of the optical neural network;
a vertical-cavity surface-emitting laser (VCSEL) layer to convert the input signal to an optical signal; and
a semiconductor absorber (SA) layer to generate an output signal of the optical neural network based on the optical signal and the weights of the optical neural network.

9. The optical neural network of claim 8, wherein a VCSEL layer includes a VCSEL cell to receive a bias voltage produced by a digital-to-analog converter.

10. The optical neural network of claim 8, wherein the SA layer includes semiconductor absorber cells to receive the optical signal from the VCSEL layer, a through-silicon-via (TSV) to deliver a bias voltage from the VCSEL layer to the SA layer.

11. The optical neural network of claim 8, wherein the SA layer is to generate the output signal based on an accumulation of outputs from two or more semiconductor absorber cells.

12. The optical neural network of claim 8, wherein the CMOS circuit layer stores one or more of the weights in a static random memory (SRAM) bank, the SRAM bank connected to an in-memory C-2C capacitor ladder to convert a corresponding one of the weights to a bias voltage.

13. The optical neural network of claim 8, wherein a programmable current mirror circuit of the VCSEL layer includes a three to one (3:1) current ratio during a time domain partial sum accumulation.

14. An apparatus, comprising:
means for generating an optical signal responsive to an input signal at a first layer of an optical neural network;
means for generating an electrical signal based on the optical signal at a second layer of the optical neural network; and
means for generating an output signal based on the electrical signal, the electrical output signal a product of the optical signal and a weight of the optical neural network stored at a third layer of the optical neural network.

15. The apparatus of claim 14, wherein the first layer, the second layer, and the third layer are heterogeneously integrated.

16. The apparatus of claim 14, wherein the first layer is a vertical-cavity surface-emitting lasers (VCSELs) layer, the second layer is a semiconductor absorber (SA) layer, and the third layer is a complementary metal-oxide-semiconductor (CMOS) circuit layer.

17. The apparatus of claim 14, wherein the means for generating the electrical signal is to generate a photodetector output based on a bias associated with a corresponding one of the weights of the optical neural network.

18. The apparatus of claim 17, wherein the one of the weights of the optical neural network is stored on a static random memory (SRAM) cell of the third layer.

19. The apparatus of claim 14, wherein the third layer includes at least one of an analog buffer to process the input signal or a comparator to process the output signal.

20. The apparatus of claim 14, wherein the second layer is to generate the output signal based on an accumulation of outputs from two or more semiconductor absorber cells.
